(19) United States
(12) Patent Application Publication
(10) Pub. No.: US 2005/0008789 A1
(43) Pub. Date: Jan. 13, 2005

(54) Method and apparatus for stabilizing optical dielectric coatings

(76) Inventors: Robert J. Rafac, Carlsbad, CA (US); Alexei Lukashev, San Diego, CA (US); Weiman Zhang Kevin, San Diego, CA (US)

Correspondence Address: William C. Cray;c/o Cymer, Inc., Legal Dept., 17075 Thornmint Court, San Diego, CA, 92127, US

(21) Appl. No.: 10/608,521

(22) Filed: Jun. 26, 2003

(51) Int. Cl. B05D 3/00

(52) U.S. Cl. 427/532

(57) ABSTRACT

A method for stabilizing a multi-layered dielectric reflectivity coating subject to compaction/densification upon exposure to DUV or shorter wavelength light, is disclosed which may comprise: applying the reflectivity coating to a reflective surface forming a coating bulk on the surface; exposing the coating bulk to a pretreatment of a sufficient amount of DUV radiation to induce sufficient densification in enough of the coating bulk to inhibit subsequent densification during continued exposure to DUV or shorter wavelength radiation. The method may also comprise the pretreatment radiation exposure amounting to energy of at least the equivalent of about 2 Bp at 9 mJ per pulse. The method may also comprise the pretreatment radiation exposure amounting the energy being delivered in at about 3 KHz pulse repetition rate. The method may also comprise the pretreatment radiation exposure amounts to energy of at least the equivalent of 15-18 mJ per pulse delivered over about 700 M-1 B pulses, i.e., about 4 days at 3 Khz or 2-3 days at 4 Khz pulse rates.

### FIELD OF THE INVENTION

The present invention related to optics containing reflectivity coatings, e.g., dielectric reflectivity coatings subject to compaction/densification when utilized in high power lasers.

### BACKGROUND OF THE INVENTION

It is well known to utilize highly reflective in applications where there is a probability of exposure to high optical fluence and over long periods of time. Such applications include, e.g., the optical pulse-stretching unit (“OpuS”) contained, e.g., in an XLA-100 excimer gas discharge laser made by the assignee of the present invention. Such highly reflective mirrors and the like, e.g., interference filters and also perhaps even anti-reflective coatings, are typically made of a substrate, e.g., a fused silica substrate with a multi-layered coating of dielectric materials of, e.g., differing materials, thicknesses and densities, as is well known in the art, e.g., a high reflectivity mirror made, e.g., by Corning, as a mirror, concave, 38.1 DIA, 1.66 mR, fused silica, part number 11290.

The differing indices of refraction of the materials can be selected to make the highly reflective mirror highly reflective within a certain relatively narrow band of wavelengths of light, as is well known in the art. While a mirror made, e.g., of metal is very broadband in reflectivity, certain highly reflective dielectric coating mirrors can be relatively narrow band around a specific wavelength λ.

FIG. 1 shows an example of one half of the generally symmetric band pass curve of intensity versus λ for such a mirror.

It is also known in the art that over time due to a phenomenon known as compaction the effective index of refraction goes up causing the curve shown in FIG. 1 to shift to the left, so-called blue shift. This causes, over time, the center wavelength λ, e.g., 193.368 for an ArF excimer laser system OpuS to migrate out of the bandpass that is shifting to the left. This in turn makes the moved reflectivity spectrum of the highly reflective mirror out of the region in which it is highly reflective (e.g., ≧99%) to a region where the mirror is much les reflective. Therefore, in that region, the mirror is much more absorptive, i.e., the coating stack becomes transmissive heating the substrate, resulting in damage to some or all of the dielectric layers, and destroying the mirror.

In the past, one solution to this problem has been to center the bandpass of the mirror when new to the red from the desired center λ, rather than having the desired center λ at the center of the band pass, and to then allow the curve to shift to the left over time, still maintaining the center λ within the band pass over time. A number of laser operating parameters, e.g., higher power in the intensity of the light emitted by the laser and higher pulse rate are preventing the utilization of this approach. This in combination with customer demands for little or no cost of continued operation after purchase of such laser systems up to pulse totals in the many billions has led to a sever need for a solution to the destabilization of the dielectric mirrors over the life of operation of such lasers.

### SUMMARY OF THE INVENTION

A method for stabilizing a multi-layered dielectric reflectivity coating subject to compaction/densification upon exposure to DUV or shorter wavelength light, is disclosed which may comprise: applying the coating to a substrate surface forming a coating bulk on the surface; exposing the coating bulk to a pretreatment of a sufficient amount of DUV radiation to induce sufficient densification in enough of the coating bulk to inhibit subsequent densification during continued exposure to DUV or shorter wavelength radiation. The method may also comprise the pretreatment radiation exposure amounting to energy of at least the equivalent of about 2 Bp at 9 mJ per pulse. The method may also comprise the pretreatment radiation exposure amounting the energy being delivered in at about 3 KHz pulse repetition rate. The method may also comprise the pretreatment radiation exposure amounts to energy of at least the equivalent of 15-18 mJ per pulse delivered over about 700 M pulses.

### BRIEF DESCRIPTION OF THE DRAWINGS

FIG. 1 shows a starting bandpass for a highly reflective dielectric mirror and a blue shifted bandpass resulting from relatively large exposure to fluence of DUV radiation;

FIG. 2 shows the results of an experiment showing the results of exposure of a low density dielectric mirror sample to scattered DV light, followed by exposure to normal air;

FIG. 3 shows the results of an experiment showing the results of direct exposure of a low density dielectric mirror sample to laser beam DUV light followed by exposure to room air.

FIG. 4 shows the results of an experiment showing the results of exposure of a high density dielectric mirror to scattered DUV laser light;

FIG. 5 shows the results of an experiment showing the results of direct exposure of a high density dielectric mirror sample to DUV laser light; and,

FIG. 6 shows the results of an experiment showing the results of direct exposure of a high density dielectric mirror sample to DUV laser light.

### DETAILED DESCRIPTION OF PREFERRED EMBODIMENTS

Applicants have discovered that after a short exposure to DUV (e.g., 193.368 nm) light the shifted bandpass curve for a given mirror tends to rebound back to the originally set center λ with an exposure to, e.g., ambient air. In operation such mirrors are usually kept in an atmosphere free environment, e.g., in a purge gas such as nitrogen. The observed shift is perhaps due to uptake of water vapor and/or other contaminants into the dielectric layer(s) of the mirror upon such exposure. FIG. 1 also shows a shifted bandpass of a long exposed mirror, which has shifted its center λ by about 10 nm, leaving the reflectivity at the center λ (e.g., 193.350 nm) deteriorated, causing mirror failure.

Applicants' observation of the shift back to the regular bandpass after exposure to only indirect (scattered) DUV laser light, upon exposure to room air, and at the same time a failure to so shift back to the normal bandpass around the desired center λ, after direct exposure to DUV laser light.

By way of example, certain experiments were conducted regarding direct and indirect (scattered) exposure of certain high reflectivity dielectric mirrors of high and low density to DUV light. The indirect exposure amounted to exposure to scattered DUV light, e.g., from outside of the beam emitted by a laser emitting light at DUV wavelengths, e.g., 193,368. Two ARO OPuS high reflectivity mirrors, sold by ARO as a mirror, concave, 38.1 DIA, 1.66 mR, fused silica, part number 112290, were examined, e.g., after about 1 billion laser light pulses (“Bp”) by the manufacturer, ARO. The inspection revealed that the reflectivity curves of the two samples both blue-shifted by approximately 10 nm relative to an unexposed spot. The reflectivity curve shift of the sample is shown in FIG. 1. The curve on the right is the reflectivity curve from an unexposed spot on the same sample, whereas the curve on the left is from the exposed spot. One can clearly see, the reflectivity curve at the exposed spot has shifted so much that the reflectivity at 193 nm dropped significantly at the end of the 1 Bp exposure. In fact, it dropped from approximately 95% to approximately 20%. A later reflectivity measurement by extending to the wavelength below 190 nm revealed that the bandwidth of the reflectivity curve did not change with exposure. In fact, the entire curve blue-shifted by approximately 10 nm. Further study of surface of the film using, e.g., a Zygo interferometer revealed that a film and substrate compaction under 193 nm exposure occurred on the two samples. The data pointed to a failure mode of film/substrate compaction that causes a substantial blue shift of the reflectivity curve to lead to a drop in reflectivity at 193 nm.

Applicants then conducted further experiments with the objective of comparing the drift rate of, e.g., three different OPuS high reflectivity mirrors under 193 nm exposure. The three sample sets in this study were an ARO baseline sample on a fused silica (“FuSi”) substrate, sold by ARO as a flat mirror on fused silica, with the same coating as a 112290, an ARO high density film on a calcium fluoride (“CaF2”) substrate with the same film formulation, sold by ARO as a flat mirror on CaF₂, part number 119679, and Corning samples with a different film formulation on an FuSi substrate, sold by Corning as a mirror, concave, 38.1 DIA, 1.66 R, fused silica, part number 11290. A Hitachi broadband reflectometer is used as the measurement tool for the reflectivity curve measurement.

The two baseline samples from ARO were the test coupons on FuSi optical flats in a real film deposition run. They are 1.5 inch×1.5 inch square. The high density samples were the films on two 40 mm outer diameter (“OD”) CaF2 optical flats. The Corning test sample was a real concave OPuS mirror with a 1.5 inch OD.

The experimental set up of the exposure test consisted of a system aperture, a shut-off valve, a beam vessel, a hermetically sealed chamber, an oxygen sensor and a water cooled Molectron power head. The exposure test was conducted at a fluence level at between 29-34 mJ/cm² with pulse energy in the range of 9.0-10.5 mJ. An oxygen level of 10 ppm was achieved before each exposure test. The oxygen level was generally less than 2 ppm during the exposure. The spot size of the beam was 2.8×11.1 mm. The energy stability was monitored throughout the exposure test using a LabView application.

Different sample sets received different exposure time. In general, the ARO baseline (low density film on FuSi substrate) samples received 330 million pulses (“Mp”), whereas the ARO high density film on CaF2 substrate samples received 1.1 Bp. The two Corning samples received 5 Bp and 264 Mp, respectively, without intermittent reflectivity shift measurement.

The 50% reflectivity point was used to access the reflectivity curve shift in all cases. The actual calculation of the shift was referred to the reflectance spectra of two chosen spots (exposed and witness spots) prior to exposure. This calculation method was use to remove any coating non-uniformity effects.

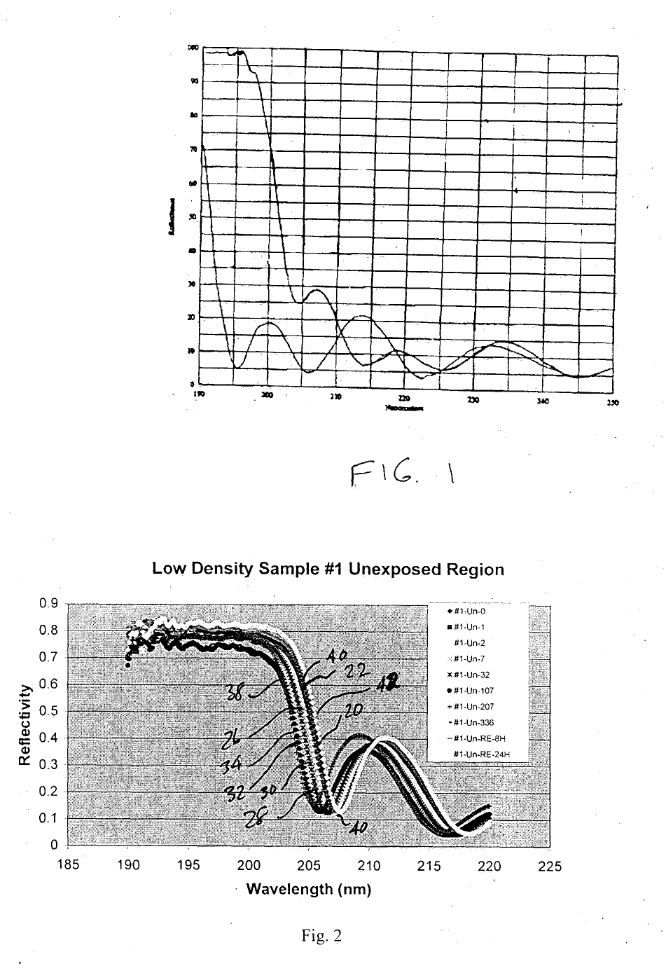

FIG. 2 is representative of the results on the two ARO low density samples, showing the reflectance spectra of a witness spot (not exposed to direct fluence) at various exposure levels up to 330 Mp and two spectra obtained by exposing the sample to room air for, respectively, 8 and 24 hours after 330 Mp exposure on ARO low density samples. In general both low density samples behaved similarly for the indirectly exposed low density samples, and, as illustrated in FIG. 2, their 50% reflectivity points both blue-shifted for ˜2.8 nm after exposure up to 330 Mp. The shift was found to be reversible after exposing the samples in room air for more than 8 hours, also as shown in FIG. 2. This strongly suggests a reversible water vapor adsorption/desorption cycle from room environment to a N₂ purged environment with exposure to scattered DUV lights.

As shown in FIG. 2, the unexposed spectrum, i.e., at 0 pulses, is indicated by reference numeral 20 and dark diamond shaped plot points. The spectrum after 1 million pulses is represented by reference numeral 22 and box shaped plot marks. The spectrum after 2 million pulses is represented by reference numeral 26 and triangular plot marks. It can be seen that there is little variation between the spectra 20, 22 and 26 in terms of blue shift.

The spectrum after 7 million pulses is represented by reference numeral 28 and x plot marks. The spectrum after 32 million pulses is represented by reference numeral 30 and asterisk plot marks. The spectrum after 107 million pulses is represented by reference numeral 32 and solid circular plot marks. The spectrum after 207 million pulses is represented by reference numeral 34 and + plot marks. The spectrum after 336 million pulses is represented by reference numeral 38 and short dash plot marks. The spectrum after exposure to ordinary air, e.g., room air, i.e., outside of the inert purged environment of, e.g., N₂, after the 330 million pulse exposure, for, respectively, 8 hours and 24 hours are represented, respectively, by reference numerals 40 and 42 and long dash and light diamond plot marks.

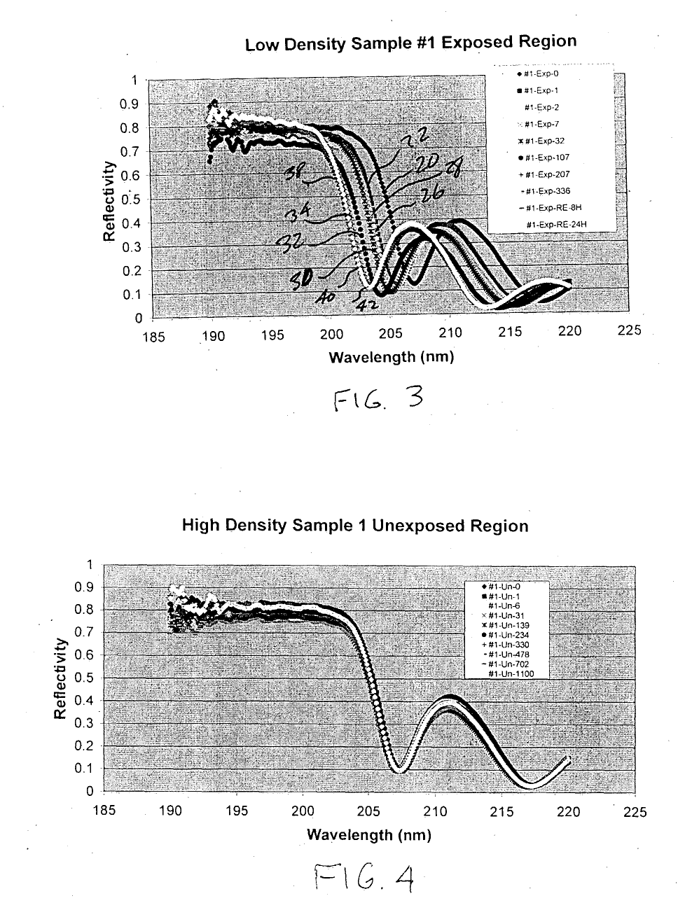

FIG. 3 shows the same reflectance spectra of a directly exposed spot at the same exposures up to 330 Mp and two spectra by exposing the samples to room air for 8 and 24 hours after 330 Mp exposure for the same low density samples. The 50% reflectivity shift, as illustrated in FIG. 3, on both samples is ˜3.7 nm towards blue side of the spectrum. The 50% reflectivity points of both samples on the directly exposed spot shifted significantly more than those of the witness spots, as illustrated in comparing FIG. 2 and FIG. 3, and, more significantly, the shift was observed to not be reversible.

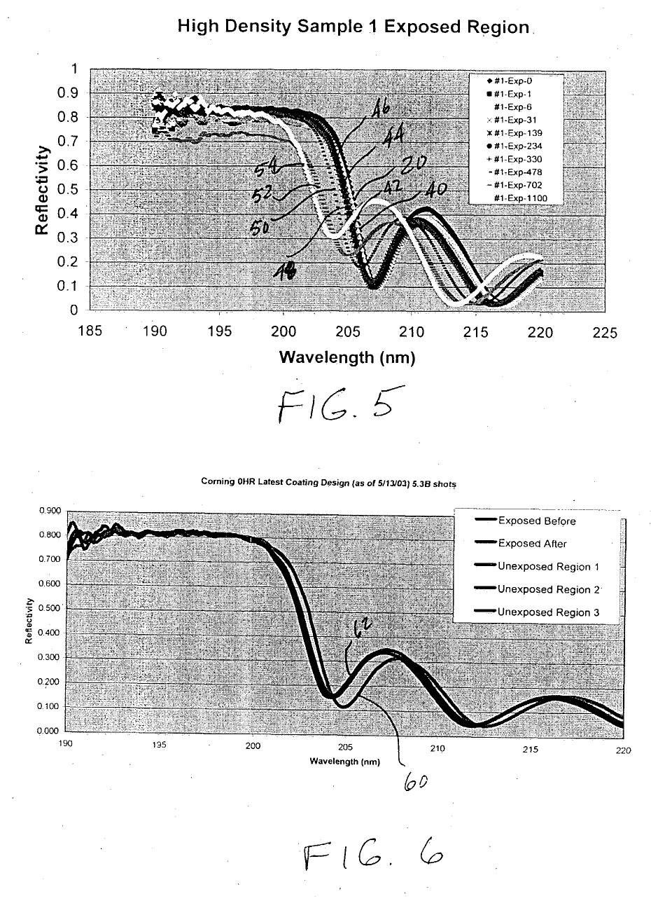

The results for the indirectly exposed two ARO high density samples are represented in FIG. 4. The 50% reflectivity point shift on the witness spots for the samples are insignificant, as represented by FIG. 4, although one ARO high density sample seemed to shift a little more than the other. The shift on the exposed spots on both samples are 3.1 and 2.8 nm towards blue side of the spectrum after 1.1 Bp, as illustrated in FIG. 5. also, as shown in FIG. 5, these blue shits of the spectra for comparable exposures are generally lower than that on the ARO low density samples as illustrated in FIG. 3. The reversibility of the shifts was not determined as yet, though the Applicants believe that the samples would show no reversibility.

Referring to FIG. 5, the 0 pulse exposure spectrum 20 is represented by dark diamond plot points, a 6 million pulse exposure spectrum 40 is represented by triangle plot marks, a 31 million pulse exposure spectrum 42 is represented by x 0plot points, a 139 million pulse exposure spectrum 44 is represented by asterisk plot points, a 234 million pulse exposure spectrum 46 is represented by solid circular plot points, a 330 million pulse exposure spectrum 48 is represented by +plot marks, a 478 million pulse exposure spectrum 50 is represented by short dash plot marks, a 702 million pulse exposure spectrum is represented by long dash plot points and a 1.1. billion pulse exposure spectrum is represented by light diamond plot marks.

The unusual shape change of the satellite peaks after 478 Mp in the 205-215 nm spectrum region appear to be interference fringes from the probing beam reflected from the front and the interface between the film and substrate. The shape may suggest a convoluted interference pattern from the surfaces with different curvatures under the probing beam. An attempt to take a Zygo image of the sample surface failed due to a strong interference from the backside reflection since these high density samples are double-side polished/coated.

The 50% reflectivity point shift dependency on number of shots is indicates that an LD sample shifts at a significantly higher rate at the first million shots then followed by a relative slower compaction, as illustrated in FIG. 3, whereas an HD sample experiences a slow shift first then a significantly accelerated rate after, e.g., about 0.5 Bp, which correlates with the spectral change observed, e.g., in FIG. 5. Another pair of the samples was found by applicants to behave similarly with slightly higher noise levels.

Two Corning OPUS HR mirrors were studied in two separate shot tests. One received 5 Bp and another received 264 Mp under the similar fluence level. The results of the two independent tests are summarized in FIGS. 15 and 16. In general, the reflectivity curves of the Corning mirrors appear to be more stable under the high fluence 193 nm exposure than the ARO LD and HD mirrors. Their 50% reflectivity points shift, if there is any, below the spectrometer resolution and measurement uncertainty for both cases.

The data also indicates that the high density ARO OPuS high reflectivity mirrors under exposure also experience at least a two-stage reflectivity curve shift. However, contrary to the low density mirrors, they exhibit a slow shift followed by a rapid shift. It is believed by applicants that the reflectivity curve shift is caused by the same mechanism as the low density samples.

The low density ARO OPuS high reflectivity mirrors under 193.368 nm exposure also experienced at least a two-stage reflectivity curve shift, a rapid water vapor desorption induced reflectivity shift at the first a few million shots than a slower shift, which may suggest a two-stage film compaction, a rapid compaction due to water vapor desorption followed by a slower film densification. The water vapor desorption induced film compaction may be the effect of both the N₂ purge environment and DUV exposure. The water desorption induced reflectivity curve shift was shown to be reversible at the witness spot that is only exposed to indirect (scattered) UV light, whereas the reflectivity curve shift in the directly exposed region appears to not be reversible.

Applicants believe that the exposure to indirect UV light removes water from the thin dielectric films on the mirror substrate, and after the OH⁻ is removed from the film material the basic structure remains the same. The shift of the spectrum back to the original center wavelength after exposure to room air, indicates that the moisture or other contaminants present in air is able to get back into the film materials, due to lack of significant compaction. The lack of compaction for indirectly exposed dielectric material, either high density or low density appears also to relate to the exposure being in a purged environment, e.g., in N₂.

The above results have led applicants to conclude that a solution to the above described problems with such mirrors exposed to such fluence over long periods is to expose the mirror to direct DUV light for a relatively short number f pulses, compared to full life, e.g., for 2b pulses at, e.g., a 9 mJ pulse energy. For roughly double that pulse energy the exposure can be lower, e.g., about 700 Mp, i.e., at, e.g., 3 KHz, exposure for several days to the DUV fluence. This can be done, e.g., prior to ever placing the mirror into its intended optical system, e.g., an OpuS on a laser system. This can be utilized to induce a pretreatment limited compaction and water vapor (and/or other contaminant) desorption.

Thereafter, the mirrors can be placed in a normal high fluence purged gas environment and significant blue shifting of the spectrum of the mirror can be essentially eliminated over the life of the mirror for, e.g., ten to twenty Bp or more.

1. A method for stabilizing a multi-layered dielectric reflectivity coating subject to compaction/densification upon exposure to DUV or shorter wavelength light, comprising:
applying the reflectivity coating to a substrate surface forming a coating bulk on the surface;
exposing the coating bulk to a pretreatment of a sufficient amount of DUV radiation to induce sufficient densification in enough of the coating bulk to inhibit subsequent densification during continued exposure to DUV or shorter wavelength radiation.

2. The method of claim 1 further comprising:
the pretreatment radiation exposure amounts to energy of at least the equivalent of about 2 Bp at 9 mJ per pulse.

3. The method of claim 2 further comprising:
the pretreatment radiation exposure amounts the energy being delivered in at about 3 KHz pulse repetition rate.

4. The method of claim 1 further comprising:
the pretreatment radiation exposure amounts to energy of at least the equivalent of 15-18 mJ per pulse delivered over about 700 M to 1B pulses.

5. The method of claim 1 further comprising:
the coating bulk forms a plurality of layers; and,
determining the amount of DUV radiation based upon a specified reduction in hygroscopicity of one or more of the layers.

6. The method of claim 1 further comprising:
the coating bulk forms a plurality of layers; and,
determining the amount of DUV radiation based upon a specified reduction in compaction of one or more of the layers.

7. The method of claim 1 further comprising:
the coating bulk forms a plurality of layers; and,
determining the amount of DUV radiation based upon a specified reduction in hygroscopicity and compaction of one or more of the layers.
